(19) United States
(12) Patent Application Publication
(10) Pub. No.: US 2006/0096924 A1
(43) Pub. Date: May 11, 2006

(54) Method for discovering suitable chromatography conditions for the separation of biological molecules

(76) Inventor: Hartmut Schlueter, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/528,103

(22) PCT Filed: Sep. 19, 2003
(86) PCT No.: PCT/DE03/03108

§ 371 Date: Oct. 3, 2005

(30) Foreign Application Priority Data
Sep. 19, 2002 (DE) 10243529.4

(51) Int. Cl. B01D 15/08

(52) U.S. Cl. 210/656; 210/198.2; 436/161; 436/178; 422/70

(57) ABSTRACT

The invention relates to a multiparallel chromatography system for developing a method for the purification of proteins and other biomolecules. The system uses cavities of multiwell plates (for example 96 well plates) filled with chromatography gels, and consists of diverse start buffers in which the samples to be chromatographed are dissolved and with which the gels are equilibrated, and solutions for desorption (elution) of the biomolecules bound to the gels. The system comprises aids for interpretation of the results obtained from the post-chromatography analyses (for example protein concentration determinations, bioassays, etc.) of the supernatants of the unbound biomolecules and/or the eluates. These aids may also consist of programs into which the results are entered and which, after processing of the results, supply interpretations and proposals for the design of the steps for the purification of a biomolecule.

The invention relates to a multiparallel method for rapidly discovering suitable chromatography parameters for the separation of biological molecules.

In particular, the invention relates to a multiparallel chromatography system for developing a method for the purification of proteins and other biomolecules. The system uses cavities of multiwell plates (for example 96 well plates) filled with chromatography gels, and consists of diverse start buffers in which the samples to be chromatographed are dissolved and with which the gels are equilibrated, and solutions for desorption (elution) of the biomolecules bound to the gels.

For the development of chromatographic fractionation steps for the purification of biomolecules, essentially three different chromatography systems from the Amersham Bioscience (Äkta systems: http://www1.amershambiosciences.com), Applied-Biosystems (BioCAD® 700E Workstation, www.appliedbiosystems.com) and BioRad (BioLogic DuoFlow, www.bio-rad.com) companies are currently being used. These systems allow a series of parameters to be varied one after the other in order to find suitable conditions for the purification of biomolecules. This search for the suitable parameters for the purification and fractionation of, for example, biomolecules, such as proteins, peptides, nucleic acids, etc., is time-consuming and generally ineffective. Thus, experience values from bio-technological/medical/chemical practice teach that, in the search for suitable chromatography conditions, a multiplicity of chromatographic media and a multiplicity of chromatographic elution parameters have to be tested for their usability in the shortest possible time in order to derive effective purification or fractionation steps from the data obtained. It has been found here that these aims can only be achieved with high cost in terms of time and money with the above-mentioned systems (experiments with the Äkta system).

WO 01/77662 A2 discloses a method for discovering suitable chromatography conditions in which multiwell plates are not used.

WO 99/24138 A1 describes a method in which various chromatography media are arranged in the cavities of a multiwell plate. These media are used for the analysis of biological substances as part of a so-called “assay”.

On the basis of this prior art, the object of the invention is therefore to provide a more effective and easier-to-carry-out method for the suitable selection of chromatography parameters for the construction of purification or fractionation steps of biological samples. A further aim of the invention is to provide a suitable computer program for the recording and interpretation of the results of the chromatography.

This object is achieved by the features indicated in Patent Claim 1.

For the purposes of the invention, “biological sample” is taken to mean purified or unpurified proteins, peptides, nucleic acids of all types, carbohydrates, lipids, low-molecular-weight metabolites or mixtures thereof. This includes, in particular—but not exclusively—complex protein mixtures of human, animal or vegetable tissues or cells as well as cells of microorganisms. The “biological sample” is also referred to below as “biomolecules”.

For the purposes of the invention, chromatography media are taken to mean two types:
a) Materials, compounds or substances which are capable of binding the biological sample. These are, for example (but not exclusively), all types of ion exchanger (anion exchangers, cation exchangers), metal affinity chromatography media, reversed-phase materials, gels for hydrophobic interaction chromatography (HIC), hydroxylapathite media (HAP) affinity chromatography media with ligands of any type, but also gels having magnetic properties (magneto-beads, coated or uncoated). The particular feature of such gels is the ability to bind the biological sample, where this must also be capable of being freed again from the binding substance by means of suitable eluents (solutions).
b) Materials, compounds, substances or solutions which are not capable of binding the biological sample. These are, for example (but not exclusively), organic and/or inorganic acids, bases, salts, derivatives thereof or solvents of all types, including aqueous solutions. The particular feature of such solutions and substances (henceforth referred to as elution solutions) is the ability for desorption (elution) of the biological sample from the chromatography gel, i.e. for shifting the equilibria of the binding of the biological sample towards the chromatography gel in such a way that the biomolecules bound to the chromatography gel have no or only low affinities to the chromatography gel after addition of the elution solution.

The invention is suitable for the automated search for suitable chromatography media and the associated buffer and elution conditions for the purification of peptides and proteins, but also other biomolecules from homogenates (crude extracts). The invention is based on the absorption of biomolecules onto gel particles, onto the so-called stationary phase. A biological sample consisting of biomolecules, such as proteins, peptides, etc., dissolved in the start buffer (mobile phase), is mixed with gel particles (so-called batch method), and, after defined incubation times, the liquid supernatant, in which the biomolecules having no affinity to the selected gel under the selected conditions are located, is removed from the gel particles. The gel particles are subsequently washed with start buffer in order to remove the non-binding molecules as substantially as possible. In the subsequent step, the biomolecules absorbed onto the gel particles are redissolved from the gel particles by means of a suitable elution solution (mobile phase) in order, after entry into the mobile phase (desorption or elution) and separation from the gel particles, to be able to be sent to diverse analytical and detection systems (photometers, bioassays, etc.). In this way, it is possible to determine a very wide variety of chromatography parameters, such as, for example, gel media, buffers, pH, solvent additives or substances for the stabilisation of biomolecules.

The invention can be carried out in an automated manner, enabling the results from, for example, 96 well chromatography to be evaluated manually or by means of a computer program, displayed clearly and prepared for interpretation. The data obtained are interpreted in such a way that proposals for the chromatographic purification of (for example) proteins from protein extracts of a biological sample follow as results of the interpretation. Possible chromatographic modes are frontal chromatography, displacement chromatography or gradient chromatography. The purification of the target protein can also include a plurality of different, successive chromatographies (combinations of chromatographies).

The invention furthermore proposes a kit in which the method according to the invention is used. This serves for commercial exploitation and may include certain chromatography samples in the form of selected chromatography media for a very wide variety of applications (depending on the biological sample to be investigated) and may be correspondingly equipped. To this end, the multiwell plates may already be prefabricated with chromatography media for binding the biological sample (group B materials) and a set of very different chromatography media (solutions of any composition) for elution (group NB materials).

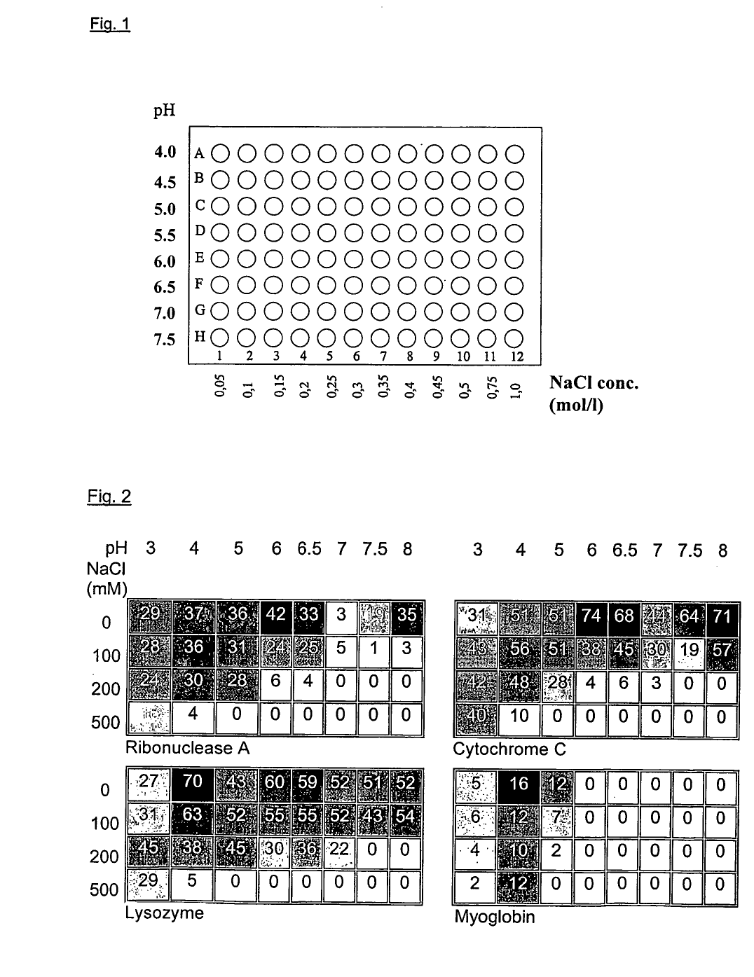

The system (kit) includes protocols for carrying out the experiments in the multiwell format with n cavities (n>1), commercially available chromatography media distributed on multiwell plates, and eluents matched to the respective chromatography media distributed on multiwell plates. The system serves for the systematic search for reproducible chromatographic purification steps for biomolecules. The system is designed for a combination of pipetting robots, but can also be used manually. Due to the various chromatography parameters selected (for example pH, ion concentration, etc.), different populations of biomolecules will bind to the gels in the different cavities. If, for example, the chromatography gel used is an anion exchanger gel, biomolecules that still have a sufficient number of negative charges at pH 4, i.e. have a low isoelectric point, will bind to the gel in B1 (FIG. 1, the solution in cavity B1 has a pH of 4 and an NaCl concentration of 50 mmol/l). The low NaCl concentration has the effect that even low-affinity biomolecules bind to the gel. Biomolecules having a significantly higher isoelectric point can be expected in cavity G11 (FIG. 1, the solution in cavity G11 has a pH of 7 and an NaCl concentration of 750 mmol/l). At the same time, due to the high NaCl concentration, only biomolecules having very high affinity will bind to the gel particles, the vast majority of the biomolecules will remain in solution. The system will also contain protocols to enable further analysis of the biomolecules concentrated on the gel particles, for example via protein determination or electrophoresis.

Advantages of the invention therefore consist in the following:
Compared with the commercially available methods, the invention, through the parallel approach in the multiwell format, facilitates the discovery of suitable chromatography media and the associated eluents in a very much shorter time than hitherto.
The search for suitable conditions for chromatographic purification or fractionation of the biomolecules can also be carried out with crude extracts. For the experiments, the biomolecules merely have to brought into solution by homogenisation steps and the homogenates freed from particles by simple centrifugation. In this point, the invention is clearly superior to other methods, such as solid-phase extraction or column chromatography, since in both cases there is a risk of blockage of the columns.
The generally very short times in which the biomolecules can come into contact with the stationary phase of the chromatography medium, which are disadvantageous in solid-phase extraction systems, can have the consequence that the biomolecules are not adsorbed completely onto the chromatography medium. This risk does not arise in the system presented here since longer incubation times can be selected.
Unlike solid-phase extraction, the system does not require a vacuum source for removal of the eluents. The problems associated with vacuum technology, such as incomplete removal of the eluents, are therefore unimportant.
The system can be employed for the development of chromatographic purification steps of biomolecules. The data obtained using the system can be used for the development of chromatography steps in frontal chromatography mode, in displacement chromatography mode or in gradient chromatography mode.
The system can (for example in combination with mass spectrometry) be utilised for comparative studies of biomolecule profiles (“profiling”) of two different states (“differential display”) in order to be able to identify molecules which are characteristic of a defined state (for example sick).
The system can be used as sample preparation for 2D electrophoresis strategies.

Advantages arise, inter alia, for the biotechnological industry and for the pharmaceuticals industry through rapid development of methods for the chromatographic purification of technologically/therapeutically/diagnostically relevant proteins. For proteome research (pharmaceuticals industry, biotechnology, biomedical research), there are advantages in the pre-fractionation of proteins for proteome analysis; basically, however, rapid development of a method for chromatographic purification of proteins of interest is created.

Further advantageous measures are contained in the other sub-claims. The invention is depicted in the attached drawings and is described in greater detail below; in the drawings:

FIG. 1 shows the diagrammatic representation of a 96 well plate, here occupied by 96 diverse start buffers for multiparallel cation exchange chromatography;

FIG. 2 shows the representation of the results of a multiparallel chromatography of a protein mixture for the discovery of suitable parameters for the chromatographic purification of 4 different target proteins. The diagram shows the absolute yields of the various target proteins (in %, based on the amount of the respective protein employed), namely of ribonuclease A (top left), cytochrome C (top right), lysozyme (bottom left) and myoglobin (bottom right), in the eluates of the multiparallel chromatography system.

FIG. 3: shows the representation of the results of a multiparallel chromatography of a protein mixture for the discovery of suitable parameters for the chromatographic purification of 4 different target proteins. The diagram shows the specific yields of the various target proteins (in %, based on the total amount of all proteins in one cavity in each case.

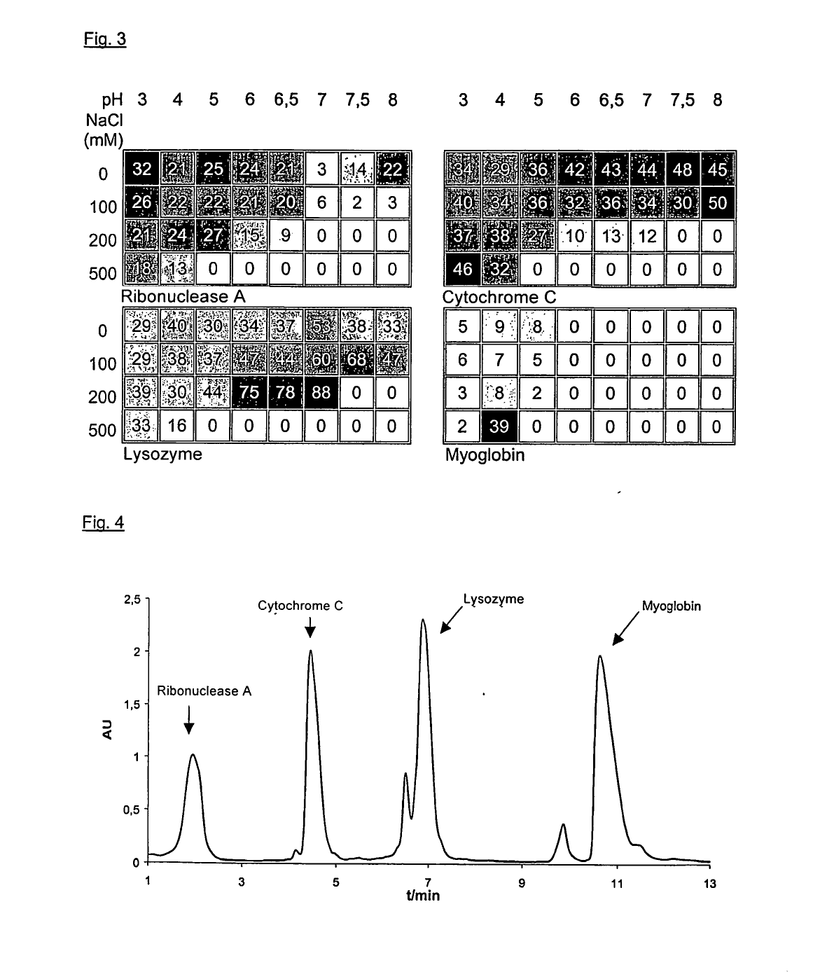

FIG. 4: shows a typical chromatogram of an analytical reversed-phase chromatography for the quantification of the individual proteins of the protein mixture, consisting of ribonuclease A (Rib), cytochrome C (Cyt C), lysozyme (Lys) and myoglobin (Myo). Abs. yield: absolute yield or recovery rate: this value relates to the amount of the respective protein originally injected into the cation exchange column (=100%).

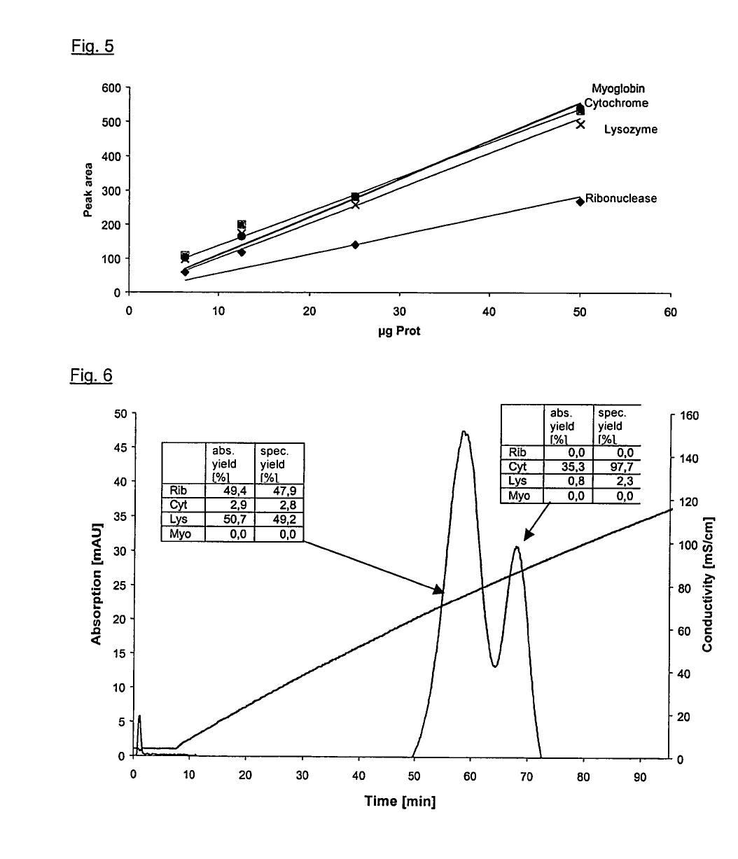

FIG. 5: shows a calibration line, produced using the reversed-phase HPLC system (FIG. 4), for the determination of the protein concentration of ribonuclease A, cytochrome C, lysozyme and myoglobin: dependence of the detected peak area on the amount of protein injected.

FIG. 6: shows a chromatogram of the cation exchange gradient chromatography of a protein mixture consisting of ribonuclease A, cytochrome C, lysozyme and myoglobin dissolved in the sample application buffer with pH 3 and 0 mM NaCl (parameter set from the experiments with the multiparallel chromatography system).

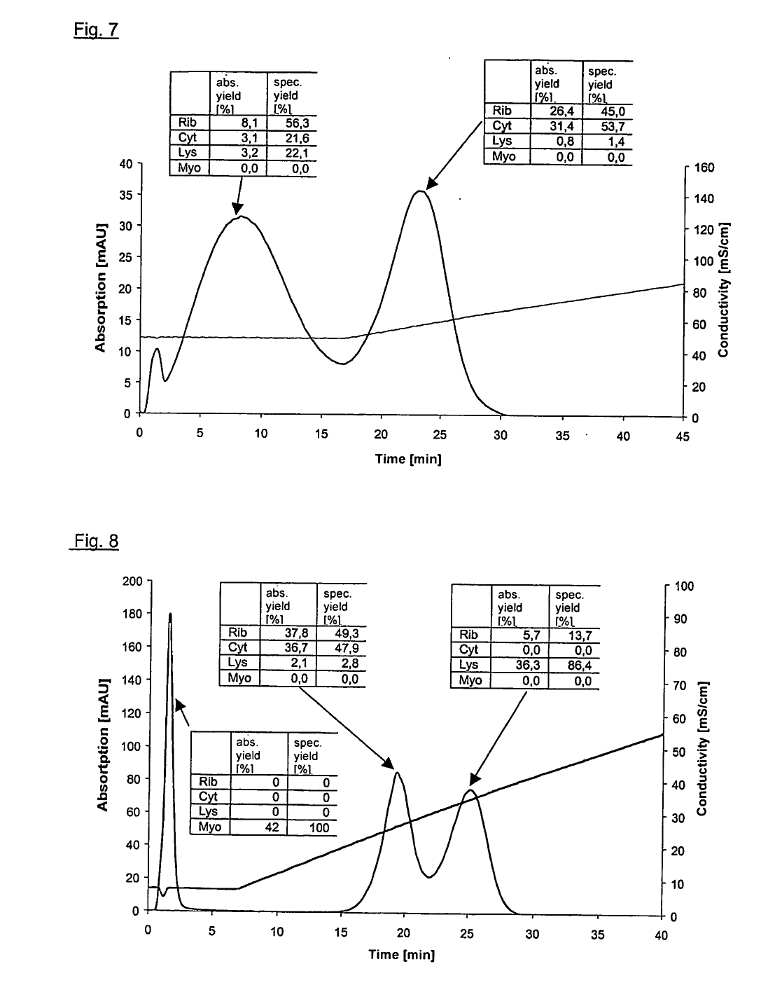

FIG. 7: shows a chromatogram of the cation exchange gradient chromatography of a protein mixture consisting of ribonuclease A, cytochrome C, lysozyme and myoglobin dissolved in a sample application buffer with pH 4 and 500 mM NaCl (parameter set from the experiments with the multiparallel chromatography system).

FIG. 8: shows a chromatogram of the cation exchange gradient chromatography of a protein mixture consisting of ribonuclease A, cytochrome C, lysozyme and myoglobin dissolved in a sample application buffer with pH 6 and 0 mM NaCl (parameter set from the experiments with the multiparallel chromatography system).

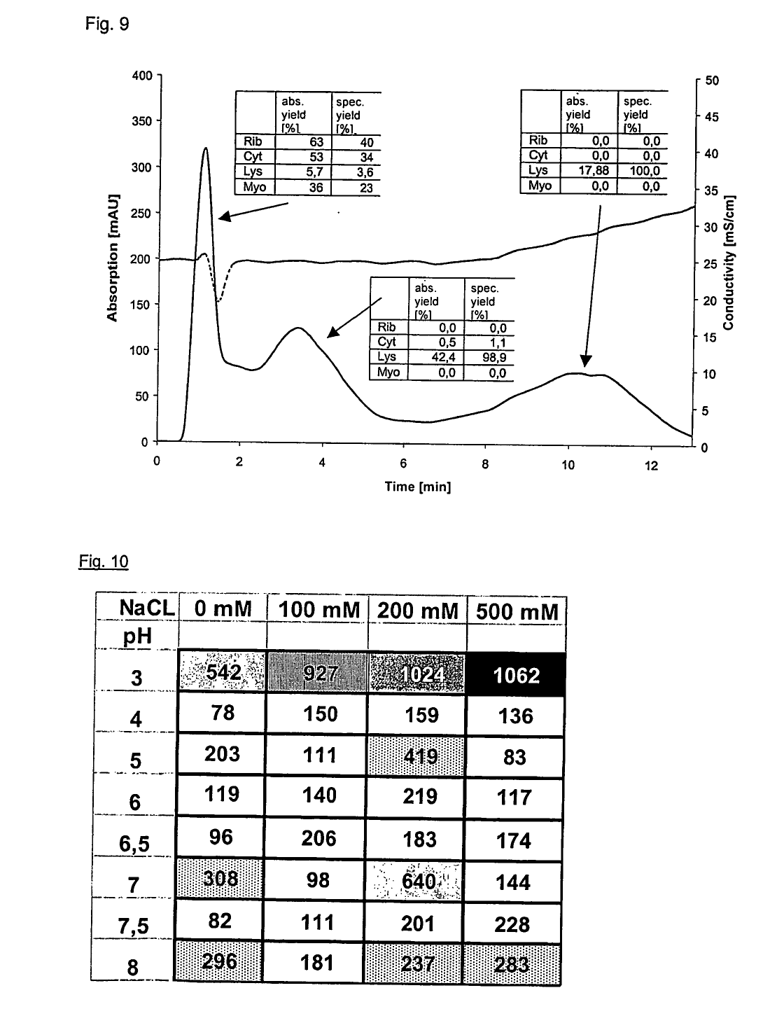

FIG. 9: shows a chromatogram of the cation exchange gradient chromatography of a protein mixture consisting of ribonuclease A, cytochrome C, lysozyme and myoglobin dissolved in a sample application buffer with pH 7 and 200 mM NaCl (parameter set from the experiments with the multiparallel chromatography system).

FIG. 10 shows a representation of the results of a 32 well matrix multiparallel cation exchange chromatography experiment for the determination of parameters for the chromatographic purification of enzymes having angiotensin conversion enzyme-like activity from a protein extract of pig kidney tissue: specific enzyme activities (quotient of absolute enzyme activity (determined by the MES method: Anal Biochem. 290, 324-9, 2001) and the protein concentration) of the eluates (one-step elution with 2 mol/l of NaCl) of the 32 fractions of a 32 well matrix cation exchange chromatography experiment in a 96 deep-well plate; for rapid recognition of the fractions having the highest specific activity, this fraction has been given a black background.

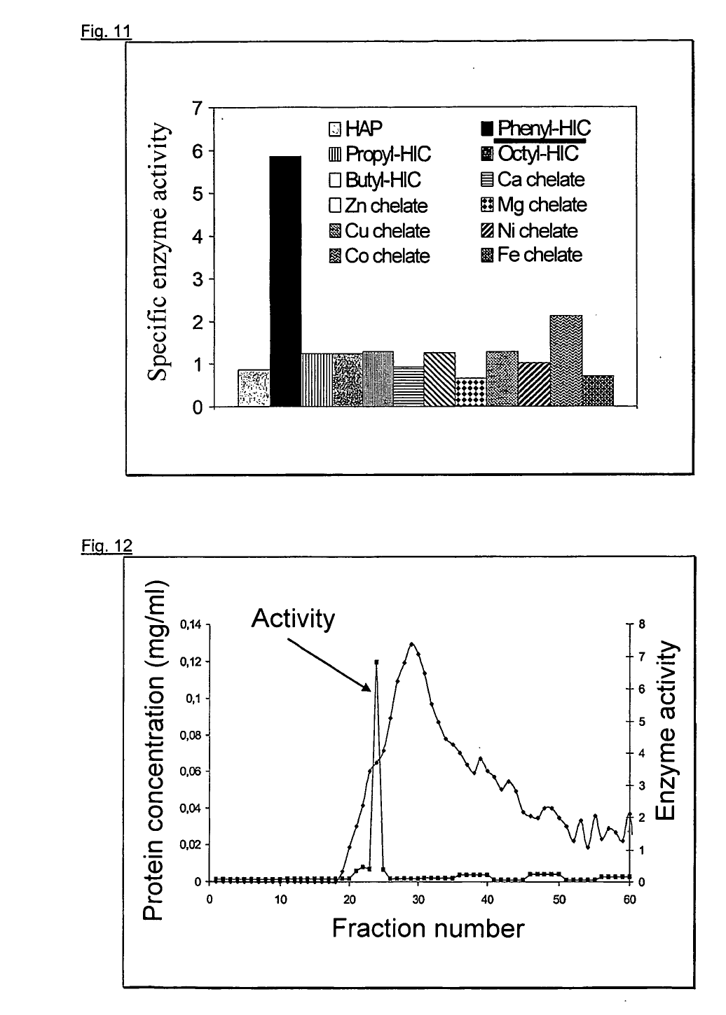

FIG. 11 shows a representation of the results of a 12 well matrix chromatography experiment for the determination of parameters for the chromatographic purification of enzymes having angiotensin conversion enzyme-like activity from an active fraction purified from pig kidney tissue: specific enzyme activities (determined by the MES method; calculated from protein concentrations and absolute enzyme activity) of the eluates of the 12 fractions of various chromatography media (HAP: hydroxylapathite gel, HIC: hydrophobic interaction chromatography gel, chelate: gel for immobilised metal affinity chromatography). For rapid recognition of the fractions having the highest specific activity, this fraction has been given a black bar.

FIG. 12 shows a chromatogram of a hydrophobic interaction chromatography of an active fraction purified from pig kidney tissue corresponding to the parameter set shown in FIG. 11. Profiles of the protein concentrations and the specific enzyme activities of ACE-like enzymes are shown.

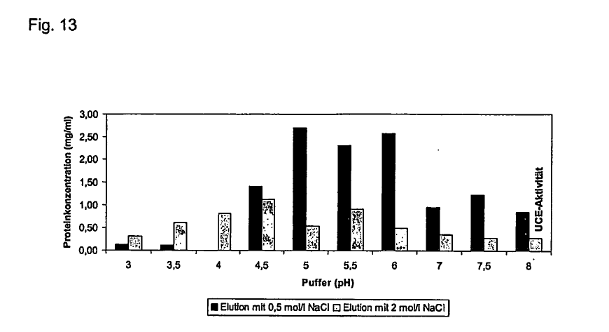

FIG. 13 shows the protein concentrations of the fractions of a multiwell cation exchange chromatography with step-gradient elution. Gradient step 1: 0.5 mol/l of NaCl; gradient step 2: 2 mol/l of NaCl. UCE: urotensin-generating activity.

The invention is described with reference to various protein mixture fractionation experiments.

FIG. 1 shows by way of example a 96 well plate (multiwell plate) which is defined by columns (X direction) and rows (Y direction) as matrix, with different chromatography media being arranged in a location-dependent manner on the matrix points, defined by the matrix, of the plate, whose individual cavities are occupied by identical amounts of chromatography gel in each case (for example by a cation exchanger gel), but have individual combinations of pH and sodium chloride concentrations. Cavity B1 in the example of FIG. 1 exhibits a pH of 4.5 and an NaCl concentration of 0.05 mol/l. Cavity G12 would have a pH of 7.0 and an NaCl conc. of 1 mol/l.

In the first fractionation experiment, a mixture of known proteins (ribonuclease A, cytochrome C, lysozyme and myoglobin) is fractionated using the multiparallel chromatography system (FIG. 2 and FIG. 3), and the applicability of the results obtained to gradient chromatography is shown (FIG. 6-9). The absolute yields (FIG. 2) or the specific yields (FIG. 3) of the various proteins measured in the eluates after parallel chromatography with the various parameters are shown. In order to quantify the composition of the proteins bound to the gel, the eluates from the multiparallel chromatography system are analysed by means of reversed-phase chromatography. FIG. 4 shows a typical reversed-phase HPLC separation of the system by means of which the quantification was carried out. The chromatogram originates from the separation of the protein mixture before processing by means of the multiparallel chromatography system. Using the reversed-phase HPLC system, a calibration line is produced for each protein (FIG. 5). For determination of the calibration lines for quantification of the individual proteins, various defined amounts of the individual proteins are injected. In order to produce the calibration line, the peak areas of the proteins are plotted against the protein concentrations.

In order to demonstrate the applicability of the parameters determined by means of the multiparallel chromatography system to gradient chromatography, some parameter sets (for the sample charging buffer) are picked out (pH 3 mM+NaCl; pH 3+0 mM NaCl; pH 4+0 mM NaCl; pH 6+0 mM NaCl; pH 7+200 mM NaCl), and the protein mixture is chromatographed under these conditions (FIG. 6-9). The resultant fractions from the various gradient chromatographies are in turn investigated by means of reversed-phase HPLC (FIG. 4) in order to determine the yields of the individual proteins of the mixture.

FIG. 3 shows that ribonuclease A can be obtained with the highest specific yield if the protein mixture is applied to the cation exchanger in a pH 3 and 0 mM NaCl buffer. A look at the result in FIG. 2 reveals that co-elution of cytochrome C and lysozyme can be expected under these conditions. The chromatogram from gradient chromatography of the protein mixture, operated with a pH 3 and 0 mM NaCl buffer as start and sample application buffer, confirms the expectation. Ribonuclease elutes together with lysozyme, and it was even possible to separate cytochrome C from the other proteins under the influence of the gradient.

FIG. 7 shows the chromatogram for the separation of the protein mixture using a pH 4 and 500 mM NaCl buffer as start and sample application buffer. Under this parameter set, the highest specific yield in the eluate of the multiparallel chromatography experiment was found for myoglobin. At first sight, the results in FIG. 3 and FIG. 7 appear contradictory. After looking at FIG. 3, it is expected that myoglobin can also be obtained with a higher specific yield by gradient chromatography. Instead, myoglobin was lost completely during the gradient chromatography. The cause is revealed in part by FIG. 2 and by analysis of the myoglobin concentration in the supernatant of the multiparallel chromatography after application of the protein mixture. A significant difference was evident here between the amount of myoglobin applied and the sum of the amount of myoglobin recovered in the eluate and the amount of myoglobin in the supernatant. This difference suggests irreversible binding of the myoglobin to the gel. Irreversible binding of the myoglobin was verified by the observation that the gel remains reddish in colour after elution with NaCl and can only be decoloured again by intensive washing with sodium hydroxide solution. This effect is even clearer in gradient chromatography since gel amounts which are able to bind about 10 times the sample applied are typically employed for these separations. The basic rule that chromatographic parameters for which greater differences between the amount applied and the sum of the yields in the eluate and the supernatant were calculated in the multiparallel chromatography experiment should be avoided is derived from this example. The absolute yields in FIG. 2 suggest that the parameter set pH 4 and 500 mM NaCl is likewise unsuitable for purification of the other proteins, which is likewise evident from the gradient chromatogram (FIG. 7).

Under the parameter set of pH 6 and 0 mM NaCl, much better results arise for the purification of myoglobin via gradient chromatography (FIG. 8), which can also be predicted from the experiments with the multiparallel chromatography system: at pH 6, no myoglobin can be detected in the eluate (FIG. 2), in contrast to the other proteins of the mixture, which bind with relatively high affinity below pH 6. The data show that myoglobin can be purified with high specific yield via frontal chromatography by means of the cation exchanger employed in the experiment with a pH 6 buffer. This conclusion is confirmed by the chromatogram in FIG. 8. Myoglobin elutes in a homogeneous fraction in the column breakthrough.

A high specific yield of lysozyme is promised by the results of multiparallel chromatography with a buffer having a pH of 7 and containing 200 mM NaCl (FIG. 3). The gradient chromatography carried out with this parameter set confirms the expectation. Shortly after the rise in the gradient, a fraction comprising virtually 100% pure lysozyme can be found.

In order to show that the method is also suitable for complex protein mixtures of unknown composition, a fractionation experiment series was carried out with a protein extract from pig kidneys. As shown in the examples mentioned below, aliquots of the tissue extract are, to this end, distributed on a multiwell plate in each of the cavities of which identical amounts of a cation exchanger gel are located. The individual cavities differ with respect to the pH and with respect to the ion strength. The result of the separation is obtained via determination of the protein concentration of the proteins bound to the gel in the individual cavities.

FIG. 10 shows the results of the determination of the specific activity of the fractions from multiwell cation exchange chromatography corresponding to Working Example 2. The data shown in FIG. 10 can be used to find suitable conditions for the purification of a sought protein in accordance with the following rules:
1. The selected chromatography (here cation exchange chromatography) can then be used as favourable initial step for concentration if the sought protein, here detected via its enzymatic activity, elutes in a fraction in which a low protein concentration compared with the other fractions can be found (for example FIG. 10 in the pH 3, 500 mmol/l NaCl fraction;), i.e. if the specific activity achieves a particularly high value.
2. If the absolute activity of a sought protein were to be found in a fraction in which a very high protein concentration occurs compared with the other fractions, other chromatography media, such as anion exchangers, should be tested as to whether the sought protein can be recovered with higher specific activity.
3. If the case described under point 2 exists and no other parameter set which satisfies the criteria described under point 1 can be found, the 2nd approach (multiwell chromatography with step-gradient elution) should be used to find suitable conditions for the purification of the sought protein.

Besides the advantage of multiwell chromatography of being able to test a large number of different chromatography parameters for their usability in a very short time, FIG. 10 shows a further advantage, which it would only be possible to track down at great effort using previous gradient chromatography techniques, namely the phenomena which in the case of the buffer with the pH values 3. Here, maxima in the specific activity which are not expected here can be seen at salt concentrations of 500 mmol/l of NaCl in each case. The expectation is that the concentration of the proteins bound to the cation exchanger is the highest at an initial concentration of 0 mmol/l of salt and the concentration of the bound proteins decreases with increasing salt concentration of the initial solution. The occurrence of the maxima described above can be explained through the higher salt concentrations favouring hydrophobic interactions (independently of the electrostatic interactions) between proteins and the gel, which results in increased absorption of proteins onto the gel. These are thus phenomena which can be referred to as non-ideal chromatography mechanisms (Schlüter H, Zidek W. J. Chromatogr. 639. 17-23 (1993)), which means that (in this case) not only electrostatic interactions, but also other interactions (here hydrophobic interactions), have a crucial influence on the binding of the proteins to the stationary phase and can thus advantageously be utilised for the separation. Phenomena of this type can be found by empirical strategies, i.e. the more parameters that can be varied, the greater the probability of finding the requisite parameters and being able to utilise them advantageously.

FIG. 11 shows, for the 3rd working example, specific enzyme activities of renin-like enzymes from the fractions of multiwell chromatography with various HIC, hydroxylapathite and IMAC (immobilised metal affinity chromatography) gels. A parameter set with which a purified active protein fraction from pig kidney extract can be purified further by gradient chromatography was sought. FIG. 12 shows the chromatogram of a hydrophobic interaction (HIC) gradient chromatography derived from the parameter sets of multiparallel chromatography of the experiment, shown in FIG. 11 (phenyl-HIC chromatography). The enzymatically active fraction elutes in the region of the gradient, which shows that the prediction that the sought target enzyme can bind to a phenyl-HIC column under the conditions described in FIG. 11 and can be chromatographed is true.

FIG. 13 shows protein concentrations of the fractions of a multiwell cation exchange chromatography with step-gradient elution. Gradient step 1: 0.5 mol/l of NaCl; gradient step 2: 2 mol/l of NaCl. UCE: urotensin-generating activity. It can be seen that a urotensin-forming activity (UCE activity) was only detectable in the fraction in which the protein extract was applied to the gel at pH 8 and which was eluted with 2 mol/l of NaCl. It is clearly evident that the highest protein amounts can be eluted with 0.5 mol/l (at pH 4.5 to 8). The UCE activity elutes in chromatography with the pH 8 buffer, but only after elution with a 2 molar salt concentration. This result is of great advantage for the purification of the UC enzyme since the UCE elutes in a fraction with low protein concentration and in this way a large amount of the accompanying proteins (about 95% of the protein amount originally applied) can be separated off.

### 1ST WORKING EXAMPLE

### Multiparallel Cation Exchange Chromatography of a Mixture of 4 Model Proteins in 32 Wells with Various Start Conditions (Variation of the pH (Number Series, “Rows”) and the Salt Concentration (Letter Series, “Columns”)) and One-Step Elution

As model proteins, ribonuclease A, cytochrome C, lysozyme and myoglobin are mixed together (1250 μg per protein). 100 μl of cation exchanger gel (Fractogel EMD (M) SO₄⁻ (Merck) per cavity are distributed over 32 cavities. As equilibration buffer (40 mM in each case), the following buffers are prepared for the cation exchanger (X direction of the deep-well matrix):

TABLE 1
Buffers for multiparallel cation exchange chromatography

| Buffer (40 mM in each case) | pH |
|---|---|
| Citric acid | 3 |
| Formic acid | 4 |
| Acetic acid | 5 |
| Malonic acid | 6 |
| MES (2-(N-morpholino)ethanesulfonic acid) | 6.5 |
| Phosphate buffer | 7 |
| Phosphate buffer | 7.5 |
| HEPES | 8 |

NaCL is admixed with the buffers in the Y direction of the deep-well matrix, so that NaCl concentrations of 0 mM NaCl, 100 mM NaCl, 200 mM NaCl, 500 mM NaCl are formed in the cavities. In parallel, a 32 well matrix buffer plate is prepared with the corresponding buffers without gel. The gels are washed 3 times with 300 μl of the respective equilibration buffer each time (from the 32 well matrix buffer plate, Table 1). Aliquots of the protein mixture are dissolved in the respective (200 μl ) sample application buffer (Table 1) and applied to the gels in the various cavities. After washing with the appropriate buffers (Table 1), the proteins are eluted with 3×100 μl of a 2 M NaCl solution. The composition of the eluates is quantified by means of a reversed-phase HPLC system (FIG. 4 and FIG. 5). In FIG. 4, 100 μl of the protein mixture (50 μg per protein), dissolved in 0.1% of TFA, were separated via a reversed-phase column (TSKgel Super-Octyl 4.6 mm ID×5.0 cm L; Tosohaas Biosep). The HPLC system used is a SMART unit (Amersham). The mobile phase consists of 0.1% of TFA in distilled water (solution A) and 0.1% of TFA in acetonitrile (solution B). The chromatography is carried out at a flow rate of 1 ml/min and with a gradient of from 23% to 44% of solution B in 12.3 min. The absorption is measured at 214 nm as a function of time. FIG. 5 shows the calibration lines for the determination of the protein concentration of ribonuclease A, cytochrome C, lysozyme and myoglobin.

In order to demonstrate the applicability of the parameters obtained by means of multiparallel chromatography, the mixtures are chromatographed in gradient chromatography mode with the same cation exchanger gel employed for the multiparallel chromatography. A self-blocked cation exchanger column (HR10/30 containing 2 ml of Fractogel EMD SO³⁻ (M), Merck) was used. The mobile phase consisted of 40 mM citric acid buffer, pH 3 without NaCl (buffer A) and 40 mM citric acid buffer, pH 3 with 2 M NaCl (buffer B). The chromatography was at a flow rate of 2.0 ml/min. The gradient had an increase from 0% to 75% of buffer B in 90 min. The composition of the fractions with UV absorption were analysed by means of reversed-phase HPLC (FIG. 4). The results are listed in the tables in FIG. 4. In FIGS. 7 to 9, the following equilibration and sample application buffers (buffer A in each case) are employed. 40 mM formic acid, pH 4 and 500 mM NaCl (FIG. 7), 40 mM malonic acid, pH 6 and 0 mM NaCl (FIG. 8), 40 mM phosphate buffer, pH 7 and 200 mM NaCl. As buffer B, 2 M NaCl are in each case added to buffers A.

### 2ND WORKING EXAMPLE

### Multiwell Cation Exchange Chromatography with Various Start Conditions (Variation of the pH (Number Series, “Rows”) and the Salt Concentration (Letter Series, “Columns”)) and One-Step Elution

A. Obtaining a Sample: Preparation of Protein Extracts from Pig Kidneys

For the preparation of protein extracts, pig kidneys are used. Immediately after removal in the abattoir, they are cooled in physiological saline solution (0.9% NaCl solution) until processed further. The kidney tissue is cut (at temperatures of 4 to 6° C.) into pieces of about 1 cm³, transferred into pre-cooled lyophilisation vessels, frozen in liquid nitrogen and stored overnight at −80° C. The tissue pieces are dried completely for about one week 1 week in the lyophilisation unit (model 2040 from Snijders Tilbug, Holland). The water-free tissue pieces are then powdered using a cereal mill (Varius, from Messerschmidt) at the finest setting. 2 g of the powder are dissolved in 20 ml of buffer (10 mM phosphate buffer, pH 7.3). A homogeniser (Ultra Turrax T 25 from Jahnke-Kunkel) is used for this purpose.

B. Preparation of the Cation Exchanger Gel (Fractogel EMD-SO3; Merck, Darmstadt) and Performance of the Multiwell Cation Exchange Chromatography with One-Step Elution:

The gel (at a filling rate of 300 μl/cavity: about 0.3 ml×100=30 ml) is washed with 5 times the gel volume with 2 molar aqueous NaCl solution and subsequently with 10 times the gel volume of water. The conductivity after the final washing operation should correspond to that of water.

The gel is subsequently distributed (300 μl/cavity) over 32 cavities of a 96 deep-well plate (2.2 ml), and 1000 μl of buffer (40 mmol/l) labelled A to H in Table 2 is added to each of the cavities in rows 1 to 8, so that one and the same buffer with identical pH is located in each row (denoted by a letter) of the 96 well plate. 400 μl of the salt solutions (NaCl, in mmol/l (final concentration): 1:0; 2:100; 3:200 and 4:500) are subsequently pipetted into each of the cavities, so that, for example, all cavities denoted by 2 contain the salt concentration of 100 mmol/l. In parallel, one or more copies of the buffers are prepared in accordance with the above-mentioned pipetting scheme, with which the individual cavities are later washed.

After equilibration, 300 μl of the protein-containing sample (protein extract, see above under A.) are added to each of the 32 cavities.

TABLE 2
Buffers for the cation exchanger

| Microtitre plate row | Buffer (40 mM final concentration) | pH |
|---|---|---|
| A | Citric acid | 3 |
| B | Formic acid | 4 |
| C | Acetic acid | 5 |
| D | Malonic acid | 6 |
| E | MES (2-(N-morpholino)ethanesulfonic acid) | 6.5 |
| F | Phosphoric acid | 7 |
| G | Phosphoric acid | 7.5 |
| H | Hepes | 8 |

After addition of the sample, sample and gel are suspended and incubated for 10 min. The 96 well plate is then centrifuged (Speed-Vac centrifuge: 1 min). The supernatant is copied onto a 96 well plate and stored for analysis (protein conc. determ., activity, etc.). The 32 different individual sample/gel suspensions in the 96 well plate are suspended with the corresponding, individual buffer solutions (300 μl in each case, the buffers are copied from a 96 deep well plate in which the individual solutions are located in accordance with the scheme indicated above) in order to wash the 32 gels, subsequently centrifuged, and the supernatant solution is pipetted off and discarded in order to remove the non-binding proteins. This operation is repeated twice. After washing, the binding proteins are eluted by pipetting a 2 molar NaCl solution into the cavities (100 μl per cavity). After centrifugation (1 min), the eluates are copied onto one or more 96 well plates in order to make the individual samples available for subsequent analysis.

Analysis of the fractions of the multiwell chromatography fractions can comprise determination of the protein concentration, the enzyme activity, detection of a protein property, for example with an antibody, and the composition of the fraction (electrophoresis, 2D electrophoresis).

The advantages of this version of the experiment are in the ideal case (i.e. if the sought protein has high affinity to the column material) finding in this way chromatography conditions under which the sought protein binds, but a majority of the accompanying proteins do not bind and in this way their separation succeeds. If the sought protein only has weak affinity, conditions under which the sought protein does not bind, but a majority of the proteins of no interest can be found. The results can then be used for frontal chromatography. In this way, it is thus possible to discover chromatography parameters (chromatography media, pH, buffers, salt concentrations, additives) for the concentration of proteins, in particular from crude extracts, furthermore the chromatographic behaviour of an unknown, sought protein can be determined, and finally binding capacities can be determined.

### 3RD WORKING EXAMPLE

### Multiwell Chromatography with Various Chromatography Gels (Hydrophobic Interaction (HIC) Gels, Hydroxylapathite Gels, Metal Affinity Chromatography Gels) and One-Step Elution

A. Obtaining a Sample: Preparation of Protein Extracts from Pig Kidneys:

In this respect, see above under 1st Working Example, section A. The protein extract was subsequently chromatographed via a cation exchanger column by the self-displacement method. The equilibration and sample application buffers used were the parameters determined in FIG. 10: the sample was dissolved in a 40 mM buffer having a pH of 3 and an addition of 500 mM NaCl and applied to the self-displacement columns. The resultant fractions were searched for angiotensin II-generating activities. The fraction having the highest specific activity was employed as sample for the subsequent experiment.

B. Preparation of the HIC Gels (Fractogel EMD Phenyl (S) Merck; Fractogel EMD Propyl 650 (S), Merck; Octyl Sepharose 4 Fast Flow Amersham Bioscience; Butyl Sepharose 4 Fast Flow, Amersham Bioscience), HAP Gels (Hydroxylapathite Gel, BioRad) and the Chelate Gel (Gel for Immobilised Metal Affinity Chromatography, Amersham Bioscience), Performance of Multiwell HIC Chromatography:

The gels (at a filling rate of 500 μl/cavity: about 0.5 ml×8=4 ml) are washed with 10 times the gel volume of water. The gels are subsequently distributed (50 μl/cavity) in cavities 1A to 4A (HIC gels), 5A (HAP gel) and 6A-12A (chelate gel) of a 96 deep-well plate (2.2 ml). 1000 μl of buffer (Table 2) are added to each of the gels in the cavities in rows 1A to 12A, so that the buffers are located in each of the cavities of the 96 well plate numbered 1 to 12, in accordance with Table 2. In parallel, one or more copies of the buffers are prepared in accordance with Table 2, with which the individual cavities are later washed. 50 μl of the protein-containing sample (protein concentration 0.3 ug/ul; protein extract preparation, see above under A.) are added to each of the 8 cavities.

TABLE 2
Buffers for multiparallel chromatography

| | Charging buffer (chelate) | |
|---|---|---|
| Row | Equilibration and sample application buffer | |
| Gel | Elution buffer | pH |
| 1 | 2 M NaCl, 0.1 M NaHCO₃ | 8.3 |
| 7.5 μl of phenyl-HIC | 0.1 M NaHCO₃ | 8.3 |
| 2 | 2 M NaCl, 0.1 M NaHCO₃ | 8.3 |
| 4 μl of propyl-HIC | 0.1 M NaHCO₃ | 8.3 |
| 3 | 2 M NaCl, 0.1 M NaHCO₃ | 8.3 |
| 6 μl of octyl | 0.1 M NaHCO₃ | 8.3 |
| 4 | 2 M NaCl, 0.1 M NaHCO₃ | 8.3 |
| 20 μl of butyl | 0.1 M NaHCO₃ | 8.3 |
| 5 | 40 mM potassium phosphate | 7 |
| 50 μl of HAP | 40 mM potassium phosphate + 500 mM | |
| 6 | 100 mM calcium chloride | |
| 40 μl of Ca-IMAC | 20 mM sodium phosphate buffer, 1 M NaCl | 7.2 |
| | 100 mM sodium phosphate buffer, 1 M NaCl | 3 |
| 7 | 100 mM magnesium chloride | |
| 40 μl of Mg-IMAC | 20 mM sodium phosphate buffer, 1 M NaCl | 7.2 |
| | 100 mM sodium phosphate buffer, 1 M NaCl | 3 |
| 8 | 100 mM nickel sulfate | |
| 40 μl of Ni-IMAC | 20 mM sodium phosphate buffer, 1 M NaCl | 7.2 |
| | 100 mM sodium phosphate buffer, 1 M NaCl | 3 |
| 9 | 100 mM cobalt chloride | |
| 40 μl of Co-IMAC | 20 mM sodium phosphate buffer, 1 M NaCl | 7.2 |
| | 100 mM sodium phosphate buffer, 1 M NaCl | 3 |
| 10 | 100 mM copper sulfate | |
| 40 μl of Cu-IMAC | 20 mM sodium phosphate buffer, 1 M NaCl | 7.2 |
| | 100 mM sodium phosphate buffer, 1 M NaCl | 3 |
| 11 | 100 mM zinc chloride | |
| 40 μl of Zn-IMAC | 20 mM sodium phosphate buffer, 1 M NaCl | 7.2 |
| | 100 mM sodium phosphate buffer, 1 M NaCl | 3 |
| 12 | 100 mM iron sulfate | |
| 40 μl of Fe-IMAC | 100 mM sodium acetate buffer, 1 M NaCl | 7.7 |
| | 100 mM sodium phosphate buffer, 1 M NaCl | 3 |

After sample application (15 μg, dissolved in the equilibration buffer), the gels are washed twice with equilibration buffer, and the binding proteins are subsequently eluted with 3 times the gel volume of elution buffer. The eluates are copied onto a 96 well plate and employed for analyses (protein conc. determ., activity, etc.). The angiotensin conversion enzyme-like enzyme activity was determined as described in Jankowski et al. 2001 (Jankowski, J. et al. (2001) Anal Biochem. 290, 324-9). The results are shown in FIG. 3.

The advantage of this application is, inter alia, that, for the planning of a gradient elution (continuous or step gradient), a frontal chromatography or a displacement chromatography using this system, the parameters under which the target protein can be purified by chromatography with high absolute or specific yields can be determined. It may furthermore be advantageous for this working example to allow results from Working Example 1 to have an influence in the experimental approach, for example to use the optimum gel determined therein or a suitable starting condition.

The checking of the applicability of the results from the multiparallel chromatography experiment described above to gradient chromatography is checked by means of the following experiment. A column is filled with an HIC gel (Fractogel EMD Phenyl (S) Merck. Column volume: 2.5 ml, diameter: 1 cm, height: 3 cm) and equilibrated with buffer A (0.1 M NaHCO₃ pH 8.3) at a flow rate of 1 ml/min. As sample, after equilibration of an enzymatically active fraction from pig kidney protein extract, obtained via cation exchange displacement chromatography, having a protein amount of 3 mg, is dissolved in 1 ml of buffer A and injected into the column. Buffer B consists of buffer A to which 2 M NaCl have been added. The gradient is developed from 0 to 100% of B in 10 column volumes.

### 4TH WORKING EXAMPLE

### Some Examples of Different Parameters and Variations Thereof which are of Importance in the Selection of Suitable Chromatography Conditions (for Various Multiwell Chromatographies) are Given Below

1. Variation of the salt anions for elution of the biomolecules from the anion exchanger: ClO₄⁻, SCN, p-tosyl, I⁻, Br⁻, NO₃⁻, Cl⁻, H₂PO₄⁻, CH₃COO⁻, F⁻
2. Variation of the additives for stabilisation of the biomolecules, such as, for example: glycerol, sucrose, sodium molybdate, ethylene glycol, urea, guanidinium chlorides, betaine, taurine, DTE, DTT, monothioglycerol, detergents, polyethylene glycol (PEG), chloroform, methanol, H₂O, protease inhibitors (EDTA, EGTA, PMSF, DFP, benzamidines, aprotinin, Pefabloc SC, TLCK, TPCK, phosphoramidon, antipain, leupeptin, pepstatin A, hirudin).

3. Ion exchange chromatography media (examples):

TABLE 3

| Gel | Matrix |
|---|---|
| DEAE-Sephadex A-25 | Dextrane |
| DEAE-Sephadex A-50 | |
| QAE-Sephadex A-25 | |
| QAE-Sephadex A-50 | |
| DEAE-Sepharose CL-6B | Agarose, cross-linked |
| DEAE-Trisacryl M | Copolymer³ |
| DEAE-Sephacel | Cellulose, beaded |
| DE 51 | Cellulose |
| DE 52 | |
| DE 53 | |
| DE 92 | |
| QA 52 | |
| QA 92 | |
| Express-Ion D | |
| Express-Ion Q | |
| DEAE A-200 Cellufine | |
| DEAE A-500 Cellufine | |
| DEAE A-800 Cellufine | |
| DEAE-Spherodex M | Dextran-coated |
| DEAE-Spherodex LS | Silica |
| DEAE Thruput | Agarose |
| Q Thruput | |
| DEAE-Sepharose FF | Agarose |

4. Hydrophobic interaction chromatography (HIC):
   Variation of the hydrophobicity of the gel (for example Butyl-Sepharose<Octyl-Sepharose<Phenyl-Sepharose)
   Variation of the gel matrix
   Variation of pH values
   Variation of salts in accordance with the Hofmeister series
   Addition of organic solvents to the start buffer or to the elution solution
5. Metal affinity chromatography (IMAC):
   Variation of the metal ions: Ca²⁺, Cd²⁺, Co²⁺, Cu²⁺, Fe³⁺, La³⁺, Mn²⁺, Ni²⁺, Zn²⁺
   Variation of the complexing group (chelate) of the gel (for example): iminodiacetic acid (IDA), tris(carboxymethyl)ethylenediamine (TED), nitrilotriacetic acid (NTA).
   Variation of the start buffer (for example): 0.5 to 2 M NaCl.
   Variation of the gel matrix.
   Variation of the elution: a) pH gradient (variation of the pH values in the direction of falling pH values). b) Elution with a competitive ligand (for example ammonium chloride, sulfate, imidazole, or histamine). c) Elution with chelates (EDTA, EGTA).
6. Hydroxylapatite: variation of the start buffer (phosphate buffer)
7. Reversed-phase (RP):
   Variation of the start buffer:
      a) Variation of the concentration of organic solvents (acetonitrile, methanol, ethanol, isopropanol),
      b) Variation of ion pair reagents (for example trifluoroacetic acid (TFA), triethylammonium acetate (TEAA), etc.)
   Variation of the elution parameters
      a) Type of organic solvent (acetonitrile, methanol, ethanol, isopropanol)
      b) Concentrations of the organic solvents
      c) Composition of the organic solvents
   Variation of the gel properties
   a) Hydrophobicity of the gel (for example C4, C8, C18)
   b) Matrix of the gel (silica or polymer)
   c) Porous gels, non-porous gels
8. Affinity chromatography:
   Variation of the gels (gels with dye ligands, gels with immobilised biomolecules (coenzymes etc.)
   Variation of the start buffer conditions (pH, ion strength)
   Variation of the elution conditions (elution with competitive ligands, elution by variation of the ion strength or pH)

### 5TH WORKING EXAMPLE

### Multiwell Cation Exchange Chromatography with Step-Gradient Elution

A. Obtaining a Sample: Preparation of Protein Extracts from Pig Kidneys:

In this respect, see above under 1st Working Example, section A. The homogenisation of the freeze-dried kidney extract was carried out here in the respective start buffer: the start buffers used were (20 mmol/l in each case): (1) citrate buffer, pH 3; (2) citrate buffer pH 3.5; (3) formate buffer pH 4; (4) succinate buffer pH 4.5; (5) acetic acid pH 5; (6) malonate buffer pH 5.5; (7) malonate buffer pH 6; (8) phosphate buffer pH 7; (9) HEPES buffer pH 7.5; (10) HEPES buffer pH 8. For each batch, about 200 mg of kidney tissue powder were dissolved in 3 ml of buffer.

B. Preparation of the Cation Exchanger Gel (Fractogel EMD-SO3; Merck, Darmstadt) and Performance of Multiwell Cation Exchange Chromatography with Step-Gradient Elution:

The gel (at a filling rate of 500 μl/cavity: about 0.5 ml×100=50 ml) is washed with 5 times the gel volume of 2 molar aqueous NaCl solution and subsequently with 10 times the gel volume of water. The conductivity after the final washing operation should correspond to that of water. The gel is subsequently distributed (500 μl/cavity) over the 10 cavities of a 96 deep-well plate (2.2 ml), and 1000 μl of buffer (20 mmol/l) of the buffers indicated under A. ((1) citrate buffer, pH 3; (2) citrate buffer pH 3.5; (3) formate buffer pH 4; (4) succinate buffer pH 4.5; (5) acetic acid pH 5; (6) malonate buffer pH 5.5; (7) malonate buffer pH 6; (8) phosphate buffer pH 7; (9) HEPES buffer pH 7.5; (10) HEPES buffer pH 8) is added to each of the cavities in rows 1 to 10. In parallel, the buffers are introduced into deep-well plates in accordance with the pipetting scheme mentioned above, with which the gels are later washed.

10 mg of the protein-containing samples, dissolved in the respective start buffer (1 to 10; protein extract, see above under A.), are added to each of the 96 cavities. After addition of the sample, sample and gel are suspended and incubated for 10 min. The 96 well plate is then centrifuged (Speed-Vac centrifuge: 1 min). The supernatant is copied onto a 96 well plate and stored for analysis (protein conc. determ., activity, etc.). The 10 different individual sample/gel suspensions in the 96 well plate are suspended with the corresponding, individual buffer solutions (500 μl in each case, the buffers are copied from a 96 deep-well plate in which the individual solutions are located in accordance with the scheme indicated above) in order to wash the gels in the 10 cavities, subsequently centrifuged, and the supernatant solution is pipetted off and discarded in order to remove the non-binding proteins. This operation is repeated 5 times.

After the washing, the binding proteins are eluted by pipetting 600 μl of a 0.5 molar NaCl solution in each case into the cavities. After centrifugation (1 min), the eluates are copied onto a 96 well plate in order to make the individual samples available for subsequent analysis.

After elution with the 1st gradient step, the proteins still binding are eluted by pipetting 600 μl of a 2 molar NaCl solution in each case into the cavities. After centrifugation (1 min), the eluates are copied onto a 96 well plate in order to make the individual samples available for subsequent analysis.

For the enzyme assay, 470 μl are taken from the eluates and mixed with 100 μl of a 100 mM NaHCO₃⁻ coupling buffer in accordance with the procedure for immobilisation of proteins on BrCN-activated Sepharose (Amersham-Bioscience), giving a pH of 8.3. This mixture is added to 200 μl of BrCN-activated Sepharose beads, and these are incubated overnight at 4° C. This was followed by deactivation steps with glycine and washing steps, in accordance with the procedure for immobilisation of proteins on BrCN-activated Sepharose (Amersham-Bioscience). The enzyme activity of a urotensin-generating enzyme (UCE) was detected by the method of Jankowski et al. 2001. For determination of the protein concentration (by the Bradford method; Kit von Pierce) of the eluates, 10 μl are taken in each case.

### 6TH WORKING EXAMPLE

### Desalination or Rebuffering of Fractions from Multiwell Chromatography

Various analytical techniques require protein fractions present in defined buffers. In order to facilitate rapid desalination or rebuffering of a maximum of 96 samples, a protocol was developed for this purpose. A 96 deep-well plate with a filter (20 μm, Macherey & Nagel) is filled with a size exclusion gel (1000 μl/cavity in each case, Biogel P6, BioRad). The size exclusion gel should be equilibrated with a buffer which suppresses electrostatic interactions between proteins and the gel. In an experimental series, it was observed that resalination of a protein solution of 2 mol/l of NaCl to 0.29 mol/l of NaCl succeeds if 350 μl of sample are applied to the cavities filled with 1000 μl of gel. The desalination is carried out by centrifugation of the sample through the size exclusion gel. In this experimental batch, a protein yield of 79% was achieved. The salt concentration in the eluate can be reduced to 0.2 mol/l if the sample volume of the sample to be rebuffered is reduced to 300 μl. However, the protein yield drops to 67% in this case.

1. Method for discovering suitable chromatography parameters for the separation of biological molecules, consisting of the following method steps
a) different chromatography media are arranged in a location-dependent manner on a multiwell plate defined by columns (X direction) and rows (Y direction) as matrix, on the matrix points of the plate defined by the matrix in the respective cavities therein, where the chromatography media consists on the one hand of materials (B) which bind the biological sample and on the other hand of materials (NB) which do not bind the biological sample,
b) the different chromatography media are brought into contact with a biological sample in the respective cavities,
c) where the chromatography media are arranged in the individual cavities of the multiwell plate in such a way that on the one hand a chromatography medium from group B and group NB is present in each individual cavity, but on the other hand this chromatography medium from group B and group NB differ at least in a single parameter,
d) the biological sample located in the respective cavities is separated into biomolecules bound to binding materials and biomolecules not bound to binding materials,
e) the bound and not-bound molecules of the biological sample are analysed for each individual cavity depending on the chromatography medium located in the respective cavity.

2. Method according to claim 1, where the biological sample is purified or unpurified proteins, peptides, nucleic acids of all types, carbohydrates, lipids and other biomolecule substance classes or low-molecular-weight metabolism products or mixtures thereof.

3. Method according to claim 1, where the chromatography media of the materials binding the biological sample (group B) are selected from solid particles having the property of absorbing biomolecules, such as, for example, affinity chromatography media, anion exchangers, hydrophobic interaction chromatography media, hydroxylapathite chromatography media, cation exchangers, metal affinity chromatography media, reversed-phase materials.

4. Method according to claim 1, where the chromatography media of the compounds not binding the biological sample (group NB) are selected from organic and/or inorganic acids, bases, salts, derivatives thereof or solvents of all types, and aqueous solutions thereof.

5. Method according to claim 1, where agents for stabilisation of the biological sample are selected from, for example: glycerol, sucrose, sodium molybdate, ethylene glycols, urea, guanidinium chloride, betaine, taurine, DTE, DTT, EDTA, EGTA, monothioglycerol, detergents, polyethylene glycol (PEG), chloroform, methanol, H₂O, protease inhibitors.

6. Method according to claim 1, where the duration of the bringing into contact of the biological sample with the chromatography media can be freely selected.

7. Method according to claim 1, where the method is automated.

8. Kit for discovering suitable chromatography conditions in the separation of biological molecules by the method according to claim 1, consisting of at least
a) a multiwell plate which is defined by columns (X direction) and rows (Y direction) as matrix, where different chromatography media are arranged in a location-dependent manner on the matrix points of the plate defined by the matrix,
b) different chromatography media for stocking the matrix points.

9. Kit according to claim 8, which contains software for the evaluation, identification and interpretation of the the method of the invention.
